(19) United States
(12) Patent Application Publication
(10) Pub. No.: US 2012/0299563 A1
(43) Pub. Date: Nov. 29, 2012

(54) POWER CONVERTER AND CONTROL METHOD USING THE SAME

(75) Inventors: Te-Lung Wu, New Taipei City (TW); Yin-Yu Chen, New Taipei City (TW)

(73) Assignee: WISTRON CORPORATION, New Taipei City (TW)

(21) Appl. No.: 13/467,055

(22) Filed: May 9, 2012

(30) Foreign Application Priority Data
May 25, 2011 (TW) 100118283

(51) Int. Cl. G05F 1/10

(52) U.S. Cl. 323/271; 323/282

(57) ABSTRACT

A power converter and a control method using the same are provided. The converter includes a power output stage, a feedback circuit, and an input detecting circuit. The power output stage transfers an input voltage to an output voltage, and adjusts the output voltage according to a feedback signal. The feedback circuit is used for generating the feedback signal associated with the output voltage. The input detecting circuit is used for detecting a variation of the input voltage to produce an input related signal associated with the input voltage. The input related signal is used to influence the feedback signal in linkage, so as to change the output voltage of the power output stage.

### CROSS-REFERENCE TO RELATED APPLICATION

This application claims the priority benefit of Taiwan application serial no. 100118283, filed on May 25, 2011. The entirety of the above-mentioned patent application is hereby incorporated by reference herein and made a part of this specification.

### BACKGROUND OF THE DISCLOSURE

1. Field of the Disclosure

The disclosure relates to a power conversion technique. Particularly, the disclosure relates to a power conversion technique having an input voltage detection mechanism.

2. Description of Related Art

With development of technology, electronic products with various functions are gradually developed, and the electronic products with various functions not only satisfy diverse needs of people, but are also widely used in people's daily life and make people's life more convenient.

The electronic product with various functions is formed by various electronic devices, and power voltages required by the electronic devices are different. Therefore, in order to maintain a normal operation of the electronic product with various functions, a power conversion circuit is required to convert an input voltage into suitable voltages for providing to the electronic devices of the electronic product.

FIG. 1 is a circuit block diagram of an existing power conversion circuit. Referring to FIG. 1, according to an existing design of the power conversion circuit 100, an output current detector 120 is used to detect an output current of a load. The output current detector 120 generates control signals for controlling switches Q3 and Q4 according to a load status of the output current, so as to change a dividing value of a feedback signal VFB. Then, a power output state 110 modulates an output voltage Vout according to the feedback voltage VFB.

When the output current of the load is increased, an input voltage Vin of the system is slightly decreased, while the input voltage Vin is slightly increased in case of a light load. However, the existing technique does not have a mechanism for detecting the input voltage Vin. Therefore, it is an important issue to develop a power conversion circuit capable of detecting the input voltage in order to change an output voltage by an output power within a shortest time, and further reduce power conversion loss.

### SUMMARY OF THE DISCLOSURE

The disclosure is directed to a power converter and a control method thereof. The power converter has a detecting circuit of an input voltage, and an output voltage is adjusted in linkage with a variation of the input voltage.

The disclosure provides a power converter including a power output stage, a feedback circuit, and an input detecting circuit. The power output stage transfers an input voltage to an output voltage, and adjusts the output voltage according to a feedback signal. The feedback circuit is coupled to the output voltage for generating the feedback signal associated with the output voltage. The input detecting circuit is used for detecting a variation of the input voltage to produce an input related signal associated with the input voltage, and the feedback signal is influenced by the input related signal in linkage, so as to change the output voltage of the power output stage.

In an embodiment of the disclosure, the feedback circuit adjusts a resistance according to the input related signal.

In an embodiment of the disclosure, the power output stage includes a driving controller, a first switch, a second switch and an inductor. The driving controller has a first end for receiving the feedback signal, and generates pulse width modulation (PWM) driving signals according to the feedback signal. A first end of the first switch is coupled to the input voltage, a control end of the first switch is coupled to an output terminal of the driving controller. A first end of the second switch is coupled to a second end of the first switch. A control end of the second switch is coupled to another output terminal of the driving controller. A second end of the second switch is coupled to ground. One end of the inductor is coupled to a junction of the first switch and the second switch. A second end of the inductor outputs the output voltage.

In an embodiment of the disclosure, the first switch and the second switch are metal-oxide semiconductor transistors or double junction transistors.

In an embodiment of the disclosure, the feedback circuit includes a first resistor and a second resistor, where one end of the first resistor is coupled to the output voltage, another end of the first resistor is coupled to one end of the second resistor, and a voltage dividing signal is generated at a junction of the first resistor and the second resistor, where the feedback signal is associated with the voltage dividing signal.

In an embodiment of the disclosure, the first resistor or the second resistor is a variable resistor, and a resistance of the variable resistor is adjusted according to the input related signal.

In an embodiment of the disclosure, the feedback circuit includes a first amplifier, and the first amplifier generates the feedback signal according to variations of the input related signal and the voltage dividing signal.

In an embodiment of the disclosure, the first amplifier is an error amplifier.

In an embodiment of the disclosure, the power output stage is a buck power output stage, a boost power output stage or a boost-buck power output stage.

In an embodiment of the disclosure, when the input detecting circuit detects the variation of the input voltage, the input detecting circuit generates the input related signal according to the input voltage, a first reference voltage and a second reference voltage, where the first reference voltage is greater than the second reference voltage.

In an embodiment of the disclosure, the input detecting circuit includes an attenuator, a comparison circuit and a second amplifier. The attenuator is coupled to the input voltage for generating a first signal varied along with the input voltage. The comparison circuit receives the first signal, and generates a second signal according to a comparison result of the first signal, the first reference voltage and the second reference voltage. The second amplifier receives the second signal and converts a strength of the second signal to produce the input related signal.

In an embodiment of the disclosure, the attenuator includes a third resistor and a fourth resistor. One end of the third resistor receives the input voltage, another end of the third resistor is coupled to one end of the fourth resistor, and the first signal is generated at a junction of the third resistor and the fourth resistor.

In an embodiment of the disclosure, the comparison circuit includes a third amplifier and a fourth amplifier. A first input terminal of the third amplifier is coupled to the first reference voltage. A second input terminal of the third amplifier is coupled to the first signal. A first input terminal of the fourth amplifier is coupled to the first signal. A second input terminal of the fourth amplifier is coupled to the second reference voltage, and output terminals of the third amplifier and the fourth amplifier are coupled to an input terminal of the second amplifier.

In an embodiment of the disclosure, the power converter further includes an output capacitor, and the output capacitor is coupled to the output voltage.

In an embodiment of the disclosure, when the input related signal represents that the input voltage is a power voltage drop, the power output stage increases the output voltage.

In an embodiment of the disclosure, when the input related signal represents that the input voltage is a power voltage raise, the power output stage decreases the output voltage.

The disclosure provides a control method of a power converter, which includes following steps. An input voltage is transferred into an output voltage. A feedback signal associated with the output voltage is generated. A variation of the input voltage is detected to generate an input related signal associated with the input voltage. The input related signal is used to influence the feedback signal, and the output voltage is adjusted according to the feedback signal.

In an embodiment of the disclosure, the step of adjusting the output voltage includes that the power converter increases the output voltage in response to the input related signal when the input signal is the power voltage drop, and the power converter decreases the output voltage in response to the input related signal when the input signal is the power voltage raise.

According to the above descriptions, according to the power converter and the control method of the disclosure, the output voltage is adjusted in linkage with the variation of the input voltage. In this way, control of the output power is quick and better, and power conversion loss is further reduced.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a circuit block diagram of an existing power conversion circuit.

FIG. 2 is a circuit block diagram of a power converter according to an embodiment of the disclosure.

FIG. 3 is a circuit block diagram of a power converter according to another embodiment of the disclosure.

FIG. 4 is a flowchart illustrating a control method of a power converter according to an embodiment of the disclosure.

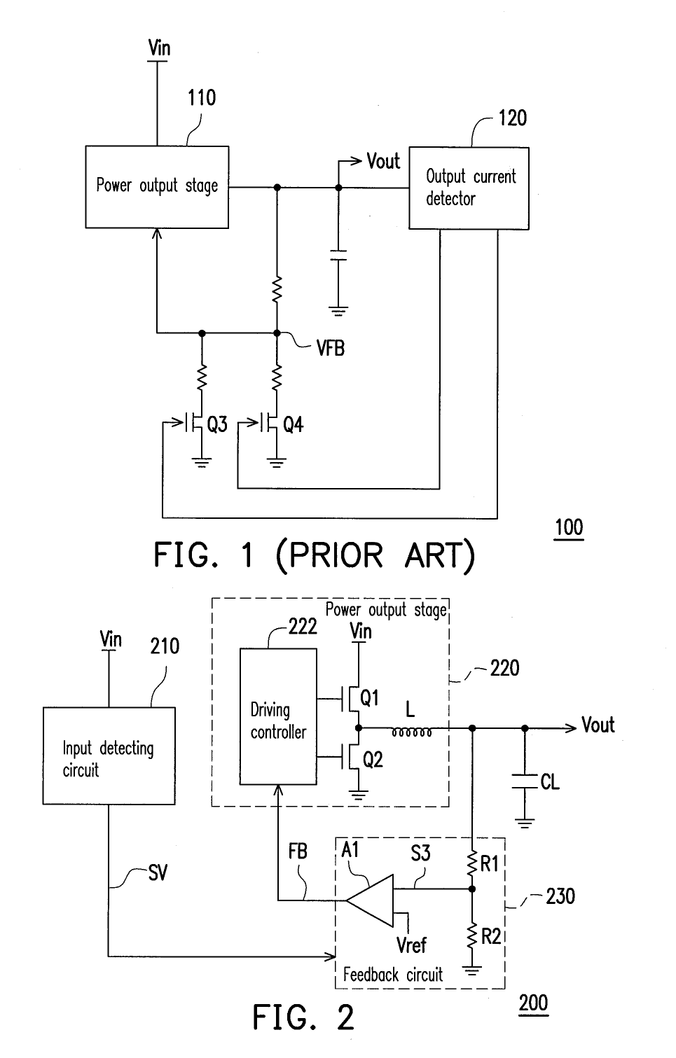

### DETAILED DESCRIPTION OF DISCLOSED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

FIG. 2 is a circuit block diagram of a power converter according to an embodiment of the disclosure. Referring to FIG. 2, the power converter 200 may include an input detecting circuit 210, a power output stage 220 and a feedback circuit 230. An input terminal of the input detecting circuit 210 receives an input voltage Vin. The input voltage Vin is provided by a power supplier, which provides main power for voltage conversion of the power converter 200. The input detecting circuit 210 can detect a variation of the input voltage Vin to produce an input related signal SV associated with the input voltage Vin. An input terminal of the power output stage 220 receives the input signal Vin, and another input terminal of the power output stage receives a feedback signal FB. The power output stage 220 performs power conversion on the input voltage Vin, and generates an output voltage Vout at an output terminal thereof. The feedback circuit 230 is coupled to the output voltage Vout, and generates the feedback signal FB associated with the output voltage Vout according to a voltage dividing principle. In case of a heavy load, the input voltage Vin of the system is slightly decreased, and in case of a light load, the input voltage Vin is slightly increased. The power converter 200 has a detection mechanism of the input voltage Vin, and regarding an operation method of the power converter 200, the input related signal SV can influence the feedback signal FB in linkage, so as to change the output voltage of the power output stage 220.

Referring to FIG. 2, the feedback circuit 230 may include an error amplifier A1, a resistor R1 and a resistor R2. One end of the resistor R1 is coupled to the output voltage Vout, another end of the resistor R1 is coupled to one end of the resistor R2, and another end of the resistor R2 is coupled to the ground. A voltage dividing signal S3 is generated at a junction of the resistor R1 and the resistor R2 and provided to a first input terminal of the error amplifier A1. A second input terminal of the error amplifier A1 receives a reference voltage Vref. The error amplifier A1 performs an error comparison on the voltage dividing signal S3 and the reference voltage Vref, and generates the feedback signal FB according to a comparison result. A relationship between a voltage magnitude of the voltage dividing signal S3 and the output voltage Vout is as follows:

S3=Vout×R2/(R1+R2).

It should be noticed that the resistor R2 can be a variable resistor, and a resistance of the variable resistor (the resistor R2) is adjusted (changed) according to the input related signal SV. However, the disclosure is not limited thereto, and in other embodiments, the resistor R1 in the feedback circuit 230 can be designed as a variable resistor, and a resistance of the resistor R1 is adjusted according to the input related signal SV. In this way, by adjusting the resistance, the voltage dividing signal S3 is dynamically varied.

Moreover, in the feedback circuit 230 of the other embodiments, the error amplifier A1 can be omitted, and the voltage dividing signal S3 can directly serve as the feedback signal FB.

The input related signal SV can directly or indirectly influence the voltage dividing signal S3 in linkage. For example, a direct linkage manner is to change the resistance to influence the voltage dividing signal S3, and an indirect linkage manner is to compare the input related signal SV and the voltage dividing signal S3 to obtain the feedback signal FB for the power output stage 220.

For another example, the resistors R1 and R2 of the feedback circuit 230 respectively have a fixed value, and the reference voltage Vref can be equal to the input related signal SV. In other words, the second input terminal of the error amplifier A1 receives the input related signal SV as the reference voltage Vref. The error amplifier A1 performs the error comparison on the voltage dividing signal S3 and the input related signal SV, and generates the feedback signal FB according to the comparison result. Therefore, the power converter 200 can generate the corresponding input related signal SV according to a detection result of the input voltage Vin, and influence the feedback signal FB in linkage through the input related signal SV, so as to change the magnitude of the output voltage Vout of the power output stage 220. However, the above embodiment is only used to describe the concept of the disclosure, and is not used to limit an actual application of the disclosure.

Referring to FIG. 2, the power output stage 220 may include a driving controller 222, a switch Q1, a switch Q2 and an inductor L. The driving controller 222 has a first end for receiving the feedback signal FB, and generates pulse width modulation (PWM) driving signals according to the feedback signal FB. A first end of the switch Q1 is coupled to the input voltage Vin. A first end of the switch Q2 is coupled to a second end of the switch Q1, and a second end of the switch Q2 is coupled to ground. A control end of the switch Q1 is coupled to an output terminal of the driving controller 222. A control end of the switch Q2 is coupled to another output terminal of the driving controller 222. The switches Q1 and Q2 accept the PWM driving control. One end of the inductor L is coupled to a junction of the switch Q1 and the switch Q2, and a second end of the inductor L is used to output the output voltage Vout.

In the present embodiment, the switch Q1 and the switch Q2 are metal-oxide semiconductor transistors, double junction transistors or other electronic devices having the same functions.

It should be noticed that the power output stage 220 has a PWM driving mechanism, which can be a buck power output stage, a boost power output stage or a boost-buck power output stage, though the disclosure is not limited thereto, and the power output stage 220 can be other types of the power output stage having the PWM driving mechanism.

Moreover, the power converter 200 may further include an output capacitor CL. The output capacitor CL can be used to ameliorate a load transient state of the power converter 200.

Although a possible pattern of the power converter has been described in the above embodiment, it should be understood by those skilled in the art that the design of the power converter varies with manufacturers, thus, application of the present disclosure should not be limited to the possible pattern. In other words, the spirit of the present disclosure is met as long as the output voltage Vout of the power output stage is adjusted in linkage according to the variation of the input voltage Vin. Several embodiments are further provided below to fully convey the spirit of the disclosure to those skilled in the art.

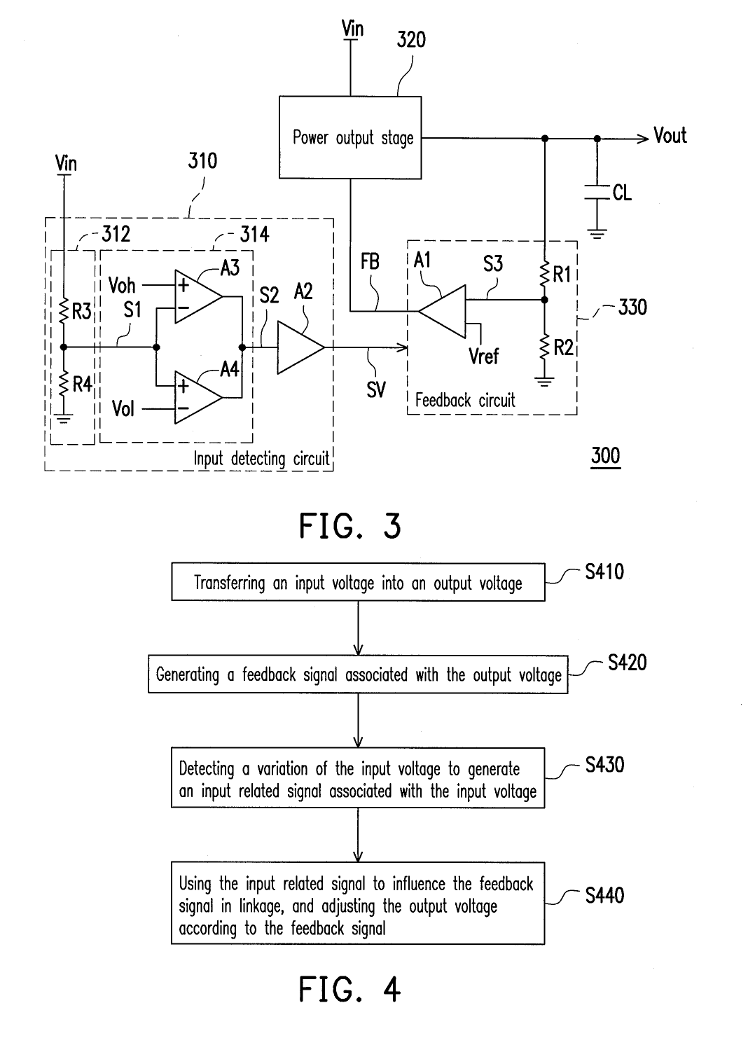

FIG. 3 is a circuit block diagram of a power converter according to another embodiment of the disclosure. Referring to FIG. 3, the power converter 300 is a variation of the power converter 200. The power converter 300 includes an input detecting circuit 310, a power output stage 320 and a feedback circuit 330. The power output stage 320 and the feedback circuit 330 are respectively similar to the power output stage 220 and the feedback circuit 230 of FIG. 2, so that details thereof are not repeated. The input detecting circuit 310 is described in detail below.

The input detecting circuit 310 may include an attenuator 312, a comparison circuit 314 and an amplifier A2, though the disclosure is not limited thereto. The attenuator 312 is coupled to the input voltage Vin for generating a first signal S1 varied along with the input voltage Vin. The first signal S1 can be generated according to the voltage dividing principle. The comparison circuit 314 receives the first signal S1, and generates a second signal S2 according to the first signal S1, a first reference voltage Voh and a second reference voltage Vol. The amplifier A2 receives the second signal S2 and converts a strength of the second signal S2 to produce the input related signal SV.

It should be noticed that the first reference voltage Voh can be greater than the second reference voltage Vol, so that the comparison circuit 314 can limit a variation range of the second signal S2 between the second reference voltage Vol and the first reference voltage Voh.

In an embodiment, the two limit voltages of the comparison circuit 314 can be designed according to a load demand. For example, the two limit voltages are designed to achieve an effect that the adjusted output voltage Vout does not exceed a withstanding voltage of the load.

Referring to FIG. 3, the attenuator 312 includes a resistor R3 and a resistor R4, though the disclosure is not limited thereto. One end of the resistor R3 receives the input voltage Vin, another end of the resistor R3 is coupled to one end of the resistor R4, another end of the resistor R4 is coupled to the ground, and the first signal S1 is generated at a junction of the resistor R3 and the resistor R4.

In FIG. 3, the comparison circuit 314 may include an amplifier A3 and an amplifier A4, though the disclosure is not limited thereto. A positive input terminal of the amplifier A3 is coupled to the first reference voltage Voh, and a negative input terminal of the amplifier A3 is coupled to the first signal S1. A positive input terminal of the amplifier A4 is coupled to the first signal, a negative input terminal of the amplifier A4 is coupled to the second reference voltage Vol, and output terminals of the amplifier A3 and the amplifier A4 are coupled to each other. Therefore, the output variation range of the comparison circuit 314 can be limited between the second reference voltage Vol and the first reference voltage Voh.

According to the above descriptions, FIG. 4 is a flowchart illustrating a control method of a power converter according to an embodiment of the disclosure. The control method of the embodiment may include following steps.

An input voltage Vin is transferred into an output voltage Vout (step S410).

A feedback signal FB associated with the output voltage Vout is generated (step S420).

A variation of the input voltage Vin is detected to generate an input related signal SV associated with the input voltage Vin (step S430).

The input related signal SV is used to influence the feedback signal FB in linkage, and the output voltage Vout is adjusted according to the feedback signal FB influenced by the input related signal SV in linkage (step S440).

In an embodiment, if the power output stage of the power converter is a buck power output stage, a design method thereof is as follows. When the input voltage Vin is a power voltage drop, the power converter increases the output voltage Vout according to the input related signal SV. When the input voltage Vin is a power voltage raise, the power converter decreases the output voltage Vout according to the input related signal SV. Generally, in case of a heavy load, the output voltage Vout is increased to achieve better performance of the load, and in case of a light load, the output voltage Vout is decreased to reduce power consumption. It should be noticed that the embodiment is only used to describe the concept of the disclosure, and the actual application of the disclosure is not limited thereto.

In summary, according to the power converter and the control method thereof, the output voltage is adjusted in linkage with the variation of the input voltage. In this way, control of the output power is quick and better, and power conversion loss is further reduced.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A power converter, comprising:
a power output stage, transferring an input voltage to an output voltage, and adjusting the output voltage according to a feedback signal;
a feedback circuit, coupled to the output voltage for generating the feedback signal associated with the output voltage; and
an input detecting circuit, detecting a variation of the input voltage to produce an input related signal associated with the input voltage, wherein the feedback signal is influenced by the input related signal in linkage, so as to change the output voltage of the power output stage.

2. The power converter as claimed in claim 1, wherein the feedback circuit adjusts a resistance according to the input related signal.

3. The power converter as claimed in claim 1, wherein the power output stage comprises:
a driving controller, having a first end receiving the feedback signal, and generating pulse width modulation (PWM) driving signals according to the feedback signal;
a first switch, having a first end coupled to the input voltage, and a control end coupled to an output terminal of the driving controller;
a second switch, having a first end coupled to a second end of the first switch, a control end coupled to another output terminal of the driving controller, and a second end coupled to ground; and
an inductor, having one end coupled to a junction of the first switch and the second switch, and a second end outputting the output voltage.

4. The power converter as claimed in claim 3, wherein the first switch and the second switch are metal-oxide semiconductor transistors or double junction transistors.

5. The power converter as claimed in claim 1, wherein the feedback circuit comprises a first resistor and a second resistor, one end of the first resistor is coupled to the output voltage, another end of the first resistor is coupled to one end of the second resistor, and a voltage dividing signal is generated at a junction of the first resistor and the second resistor, wherein the feedback signal is associated with the voltage dividing signal.

6. The power converter as claimed in claim 5, wherein the first resistor or the second resistor is a variable resistor, and a resistance of the variable resistor is adjusted according to the input related signal.

7. The power converter as claimed in claim 5, wherein the feedback circuit further comprises a first amplifier, and the first amplifier generates the feedback signal according to variations of the input related signal and the voltage dividing signal.

8. The power converter as claimed in claim 7, wherein the first amplifier is an error amplifier.

9. The power converter as claimed in claim 1, wherein the power output stage is a buck power output stage, a boost power output stage or a boost-buck power output stage.

10. The power converter as claimed in claim 1, wherein when the input detecting circuit detects the variation of the input voltage, the input detecting circuit generates the input related signal according to the input voltage, a first reference voltage and a second reference voltage, wherein the first reference voltage is greater than the second reference voltage.

11. The power converter as claimed in claim 10, wherein the input detecting circuit comprises:
an attenuator, coupled to the input voltage, for generating a first signal varied along with the input voltage;
a comparison circuit, receiving the first signal, and generating a second signal according to the first signal, the first reference voltage and the second reference voltage; and
a second amplifier, receiving the second signal, and converting a strength of the second signal to produce the input related signal.

12. The power converter as claimed in claim 11, wherein the attenuator comprises a third resistor and a fourth resistor, and one end of the third resistor is coupled to the input voltage, another end of the third resistor is coupled to one end of the fourth resistor, and the first signal is generated at a junction of the third resistor and the fourth resistor.

13. The power converter as claimed in claim 11, wherein the comparison circuit comprises:
a third amplifier, having a first input terminal coupled to the first reference voltage, and a second input terminal coupled to the first signal; and
a fourth amplifier, having a first input terminal coupled to the first signal, a second input terminal coupled to the second reference voltage, and output terminals of the third amplifier and the fourth amplifier coupled to an input terminal of the second amplifier.

14. The power converter as claimed in claim 1, wherein the power converter further comprises an output capacitor coupled to the output voltage.

15. The power converter as claimed in claim 1, wherein when the input related signal represents that the input voltage is a power voltage drop, the power output stage increases the output voltage.

16. The power converter as claimed in claim 1, wherein when the input related signal represents that the input voltage is a power voltage raise, the power output stage decreases the output voltage.

17. A control method of a power converter, comprising:
transferring an input voltage into an output voltage;
generating a feedback signal associated with the output voltage;
detecting a variation of the input voltage to generate an input related signal associated with the input voltage; and
using the input related signal to influence the feedback signal in linkage, and adjusting the output voltage according to the feedback signal.

18. The control method of the power converter as claimed in claim 17, wherein the step of adjusting the output voltage comprises:
the power converter increasing the output voltage in response to the input related signal when the input voltage is a power voltage drop, and the power converter decreasing the output voltage in response to the input related signal when the input voltage is a power voltage raise.
